(19) United States
(12) Patent Application Publication
(10) Pub. No.: US 2025/0330247 A1
(43) Pub. Date: Oct. 23, 2025

(54) CODED MODULATION WITH TWO-STAGE DECODING FOR IMPROVED FOUR-DIMENSIONAL GEOMETRIC SHAPING

(71) Applicant: HUAWEI TECHNOLOGIES CO., LTD., SHENZHEN (CN)

(72) Inventors: Yoones HASHEMI TOROGHI, Kanata (CA); Hamid EBRAHIMZAD, Ottawa (CA); Bashirreza KARIMI, Kanata (CA); Chunpo PAN, Kanata (CA)

(73) Assignee: HUAWEI TECHNOLOGIES CO., LTD., SHENZHEN (CN)

(21) Appl. No.: 18/642,286

(22) Filed: Apr. 22, 2024

(51) Int. Cl. H04B 10/516; H04L 1/00

(52) U.S. Cl. CPC H04B 10/516; H04L 1/0061

(57) ABSTRACT

Methods, apparatus, and systems for coded modulation towards data transmissions across optical communication networks are provided. At a network transmitter, sequences of data bits encoded by forward error correction are partitioned and then selectively buffered. Each part of a sequence is mapped to a respective transmission symbol, such that the transmission symbols together represent the whole sequence. Upon receipt of the transmission symbols at a network receiver, two-stage decoding that involves counteractive buffering is used to decode the transmitted symbols. In some embodiments, symbol mapping involves geometric shaping of constellation points by a neural network to maximize generalized mutual information.

### CROSS-REFERENCE TO RELATED APPLICATIONS

This is the first application filed for the present invention.

### FIELD OF THE INVENTION

The present invention pertains to optical communication and in particular to methods, apparatus, and systems for coded modulation.

### BACKGROUND

Commercially available optical transceivers are capable of operating at transmission rates in excess of 800 gigabits-per-second. At these high speeds, coded modulation (CM) involving forward error correction (FEC) is important for minimizing the occurrence of errors in transmissions. Concatenated FEC (CFEC) and open FEC (OFEC) are FEC schemes for the 400G ZR and 400G ZR+ standards for optical communication, respectively. CFEC is a doubly coded scheme, having inner and outer encoders and decoders, whereas OFEC uses iterative error correction. CM employing these FEC schemes such as 16-quadrature amplitude modulation (16QAM), or others, falls short of the Shannon limit for error-free transmission rates by a large margin. Strategies for closing the gap by increasing spectral efficiency through signal shaping have been investigated. These strategies include probabilistic amplitude shaping (PAS) and two-dimensional geometric shaping (GS); however, a significant gap with the Shannon limit persists. For example, the 16QAM scheme for CM in the 400G ZR and 400G ZR+ standards has a 1.40 dB gap with the Shannon limit for a spectral efficiency of about 3.5 bits per symbol.

Therefore, there is a need for methods, apparatus, and systems for CM that obviate or mitigate one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide methods, apparatus, and systems for CM.

A first aspect of the present disclosure it to provide a method for a transmitter for providing a data message to a receiver. The data message may have a plurality of data bits. The method may comprise, at the transmitter, encoding, in accordance with one or more forward error correction (FEC) codes, the plurality of data bits to obtain a plurality of sequences of coded bits and partitioning each sequence of coded bits into a respective first group of coded bits and a respective second group of coded bits. The method may further comprise, at the transmitter and for each sequence of coded bits: buffering the respective second group of coded bits to delay, by a pre-determined duration, the respective second group of coded bits with respect to the respective first group of coded bits; mapping the respective first group of coded bits to a respective first symbol; mapping the respective second group of coded bits to a respective second symbol; transmitting, to the receiver through an optical communication link, the respective first symbol; and subsequently transmitting, to the receiver, through the optical communication link, in accordance with the pre-determined duration, the respective second symbol.

In some embodiments of the first aspect, each sequence of coded bits may have N data bits, with N being a natural integer. For each sequence of coded bits, the respective first group of coded bits may define a respective first sub-sequence of data bits and the respective second group of coded bits may define a respective second sub-sequence of data bits. The method may further comprise, at the transmitter, obtaining a first set of X constellation points and a second set of Y constellation points, where X and Y are natural integers and have a product greater than or equal to two raised to the power of N. Each constellation point of the first set of X constellation points and the second set of Y constellation points may correspond to an amplitude and phase and have associated thereto at least one respective sequence of mapping bits. In these embodiments, for each sequence of coded bits, mapping the respective first group of coded bits to the respective first symbol may include assigning, to the respective first group of coded bits, a respective first constellation point from among the first set of X constellation points in accordance with the respective sequence of mapping bits and the respective first sub-sequence of data bits, and mapping the respective second group of coded bits to the respective second symbol may include assigning, to the respective second group of coded bits, a respective second constellation point from among the second set of Y constellation points in accordance with the respective sequence of mapping bits and the respective second sub-sequence of data bits. Furthermore, for each sequence of coded bits, the respective first symbol may have the amplitude and phase corresponding to the respective first constellation point, and the respective second symbol may have the amplitude and phase corresponding to the respective second constellation point.

In some embodiments of the first aspect, the optical communication link may have associated thereto a generalized mutual information (GMI) metric. In these embodiments, the first set of X constellation points and the second set of Y constellation points may define a grouping of constellation points, and the grouping of constellation points may correspond to a maximum of the GMI metric.

In some embodiments of the first aspect, each sequence of coded bits may have B coded bits, where B is a natural integer and the pre-determined duration depends from B. In some embodiments, the one or more FEC codes may include at least one zipper code. In some other embodiments, each sequence of coded bits may include eight coded bits, and, for each sequence of coded bits, the respective first group of coded bits may include six coded bits, and the respective second group of coded bits may include two coded bits.

A second aspect of the present disclosure is to provide a method for decoding an encoded message. The method may comprise, at a receiver, receiving, from a transmitter, the encoded message through an optical communication link. The encoded message may include a plurality of first symbols and a plurality of second symbols, with each one of the plurality of second symbols corresponding to a respective one of the plurality of first symbols and having associated thereto a delay with respect to the corresponding first symbol. The method may further comprise, at the transmitter and for each one of the plurality of first symbols: de-mapping the respective first symbol to obtain a respective plurality of soft decoded values; buffering the respective plurality of soft decoded values for a duration of the delay of the corresponding second symbol; and decoding, in accordance with one or more forward error correction (FEC) codes, the respective plurality of soft decoded values to obtain a respective plurality of decoded bits. The method may further comprise, at the transmitter and for each one of the plurality of second symbols: de-mapping, in accordance with a respective set of decoded bits of the corresponding first symbol, the respective second symbol to obtain a respective plurality of soft decoded values; and decoding, in accordance with the one or more FEC codes, the respective plurality of soft decoded values to obtain a respective plurality of decoded bits.

In some embodiments of the second aspect, for each one of the plurality of first symbols and each one of the plurality of second symbols, each one of the respective plurality of soft decoded values may be a log likelihood ratio. In some embodiments, for each one of the plurality of first symbols, the respective plurality of soft decoded values may include six soft decoded values, and the respective plurality of decoded bits may include six decoded bits. Furthermore, for each one of the plurality of second symbols, the respective plurality of soft decoded values may include two soft decoded values, the respective plurality of decoded bits may include two decoded bits, and the respective set of decoded bits of the corresponding first symbol may include two decoded bits of the corresponding first symbol.

A third aspect of the present disclosure is to provide, a method for providing a sequence of N data bits of a data message to a receiver, where N is a natural integer. The method may comprise, at a transmitter, partitioning the sequence of N data bits into a first sub-sequence of data bits and a second sub-sequence of data bits, and obtaining a first set of X constellation points and a second set of Y constellation points, where X and Y are natural integers and having a product greater than or equal to two raised to the power of N. Each constellation point of the first set of X constellation points and the second set of Y constellation points may correspond to an amplitude and phase and have associated thereto at least one respective sequence of mapping bits. The method may further comprise assigning, to the first sub-sequence of data bits, a first constellation point from among the first set of X constellation points in accordance with the at least one respective sequence of mapping bits, and assigning, to the second sub-sequence of data bits, a second constellation point from among the second set of Y constellation points in accordance with the at least one respective sequence of mapping bits. The method may still further comprise transmitting, to the receiver through an optical communication link, a first symbol having the amplitude and phase corresponding to the first constellation point, and a second symbol having the amplitude and phase corresponding to the second constellation point.

In some embodiments of the third aspect, the optical communication link may have associated thereto a GMI metric. In these embodiments, the first set of X constellation points and the second set of Y constellation points may define a grouping of constellation points, and the grouping of constellation points may correspond to a maximum of the GMI metric.

In some embodiments of the third aspect, N may be eight, X may be 40, and Y may be 40.

A fourth aspect of the present disclosure is to provide a network system comprising a transmitter, an optical communication link, and a receiver coupled to the transmitter through the optical communication link. The transmitter may be configured to encode a data message as a plurality of sequences of coded bits in accordance with one or more FEC codes, with each sequence of coded bits including a respective first group of coded bits and a respective second group of coded bits. The transmitter may be further configured to, for each sequence of coded bits: buffer the respective second group of coded bits to delay, by a pre-determined duration, the respective second group of coded bits with respect to the respective first group of coded bits; map the respective first group of coded bits to a respective first symbol and the respective second group of coded bits to a respective second symbol; and transmit the respective first symbol and the respective second symbol. The receiver may be configured to, for each sequence of coded bits: receive the respective first symbol and the respective second symbol; de-map the respective first symbol to obtain a respective first plurality of soft decoded values; buffer the respective first plurality of soft decoded values for the pre-determined duration; decode, in accordance with the one or more FEC codes, the respective first plurality of soft decoded values to obtain a respective first plurality of decoded bits; de-map, in accordance with a respective set of decoded bits of the respective first symbol, the respective second symbol to obtain a respective second plurality of soft decoded values; and decode, in accordance with the one or more FEC codes, the respective second plurality of soft decoded values to obtain a respective second plurality of decoded bits.

In some embodiments of the fourth aspect, each sequence of coded bits may have N data bits, where N is a natural integer, and, for each sequence of coded bits, the respective first group of coded bits may define a respective first sub-sequence of data bits and the respective second group of coded bits may define a respective second sub-sequence of data bits. The transmitter may be further configured to obtain a first set of X constellation points and a second set of Y constellation points, where X and Y are natural integers and have a product greater than or equal to two raised to the power of N. Each constellation point of the first set of X constellation points and the second set of Y constellation points may correspond to an amplitude and phase and have associated thereto at least one respective sequence of mapping bits. The transmitter may still be further configured to, for each sequence of coded bits: map the respective first group of coded bits to the respective first symbol includes being configured to assign, to the respective first group of coded bits, a respective first constellation point from among the first set of X constellation points in accordance with the at least one respective sequence of mapping bits and the respective first sub-sequence of data bits, and map the respective second group of coded bits to the respective second symbol includes being configured to assign, to the respective second group of coded bits, a respective second constellation point from among the second set of Y constellation points in accordance with the at least one respective sequence of mapping bits and the respective second sub-sequence of data bits. For each sequence of coded bits, the respective first symbol may have the amplitude and phase corresponding to the respective first constellation point, and the respective second symbol may have the amplitude and phase corresponding to the respective second constellation point.

In some embodiments of the fourth aspect, the transmitter may be further configured to partition each sequence of coded bits to produce the respective first group of coded bits and the respective second group of coded bits.

In some embodiments of the fourth aspect, for each sequence of coded bits, each one of the respective first plurality of soft decoded values and each one of the respective second plurality of soft decoded values may be a log likelihood ratio.

A fifth aspect of the present disclosure is to provide a network transmitter device comprising: a FEC encoder configured to encode a data message as a plurality of sequences of coded bits in accordance with one or more FEC codes, with each sequence of coded bits including a respective first group of coded bits and a respective second group of coded bits; a buffer component configured to buffer, for each sequence of coded bits, the respective second group of coded bits to delay, by a pre-determined duration, the respective second group of coded bits with respect to the respective first group of coded bits; and a symbol mapping component configured to map, for each sequence of coded bits, the respective first group of coded bits to a respective first symbol and the respective second group of coded bits to a respective second symbol.

In some embodiments of the fifth aspect, each sequence of coded bits may have N data bits, where N is a natural integer, and, for each sequence of coded bits, the respective first group of coded bits may define a respective first sub-sequence of data bits and the respective second group of coded bits may define a respective second sub-sequence of data bits. The symbol mapping component may be further configured to obtain a first set of X constellation points and a second set of Y constellation points, where X and Y are natural integers and have a product greater than or equal to two raised to the power of N. Each constellation point of the first set of X constellation points and the second set of Y constellation points may correspond to an amplitude and phase and have associated thereto at least one respective sequence of mapping bits. In these embodiments, the symbol mapping component being configured to, for each sequence of coded bits, map the respective first group of coded bits to the respective first symbol may include being configured to assign, to the respective first group of coded bits, a respective first constellation point from among the first set of X constellation points in accordance with the at least one respective sequence of mapping bits and the respective first sub-sequence of data bits. Furthermore, the symbol mapping component being configured to, for each sequence of coded bits, map the respective second group of coded bits to the respective second symbol may include being configured to assign, to the respective second group of coded bits, a respective second constellation point from among the second set of Y constellation points in accordance with the at least one respective sequence of mapping bits and the respective second sub-sequence of data bits. For each sequence of coded bits, the respective first symbol may have the amplitude and phase corresponding to the respective first constellation point, and the respective second symbol may have the amplitude and phase corresponding to the respective second constellation point.

A sixth aspect of the present disclosure is to provide a network receiver device comprising a symbol de-mapping component coupled to a FEC decoder and further comprising a buffer component coupled to the symbol de-mapping component and the FEC decoder. The symbol de-mapping component may be configured to receive an encoded message including a plurality of first symbols and a plurality of second symbols. The encoded message may be encoded with one or more FEC codes, and each one of the plurality of second symbols may correspond to a respective one of the plurality of first symbols and have associated thereto a delay with respect to the corresponding first symbol. The symbol de-mapping component may be further configured to de-map each one of the plurality of first symbols to obtain a respective plurality of soft decoded values. The buffer component may be configured to buffer, for each one of the plurality of first symbols, the respective plurality of soft decoded values for a duration of the delay of the corresponding second symbol. The FEC decoder may be configured to decode, for each one of the plurality of first symbols and in accordance with the one or more FEC codes, the respective plurality of soft decoded values to obtain a respective plurality of decoded bits. The symbol de-mapping component may still be further configured to de-map each one of the plurality of second symbols, in accordance with a respective set of decoded bits of the corresponding first symbol, to obtain a respective plurality of soft decoded values, and the FEC decoder may be further configured to decode, for each one of the plurality of second symbols and in accordance with the one or more FEC codes, the respective plurality of soft decoded values to obtain a respective plurality of decoded bits.

In some embodiments of the sixth aspect, for each one of the plurality of first symbols and each one of the plurality of second symbols, each one of the respective plurality of soft decoded values may be a log likelihood ratio.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1A shows a scheme for CM encoding, according to embodiments of the present disclosure.

FIG. 1B shows a scheme for CM decoding, according to embodiments of the present disclosure.

FIG. 2 shows a method for transmitting a message using CM, according to embodiments of the present disclosure.

FIG. 3 shows a method for geometric shaping, according to embodiments of the present disclosure.

FIG. 4A shows a graph of examples of constellation points for a first set of constellation points, according to embodiments of the present disclosure.

FIG. 4B shows a graph of examples of constellation points for a second set of constellation points, according to embodiments of the present disclosure.

FIG. 5 shows a schematic of an apparatus for CM according to embodiments of the present disclosure.

FIG. 6 shows a schematic of an embodiment of an electronic device that may implement at least part of the methods and features of the present disclosure.

It will be noted that throughout the appended drawings, like features are identified by like reference numerals.

### DETAILED DESCRIPTION

Embodiments of the present disclosure are generally directed towards providing methods, apparatus, and systems for CM with four-dimensional GS enabled by two-stage decoding. In embodiments of the present disclosure, data bits intended to be transmitted through an optical communication link may be encoded with an FEC code to obtain coded sequences of bits. Each sequence may be partitioned into two groups of bits, one of which may be buffered to delay it with respect to the other. Each group of bits for a sequence may then be mapped to a respective symbol for transmission (i.e., a first symbol and a delayed, second symbol). Transmitted symbols may be decoded through two stages. The first symbol may be de-mapped to log likelihood ratios (LLRs), which may then be buffered to counteract the delay of the second symbol and may be decoded as data bits. The second symbol may be de-mapped and decoded using a set of decoded bits corresponding to the first symbol. In some embodiments of the present disclosure, a neural network may be used to select a respective set of constellation points for mapping each group of bits to a respective symbol. The sets of constellation points may be selected to maximize generalized mutual information (GMI).

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. The terms in each of the following sets may be used interchangeably throughout the disclosure: “input” and “data message”; “4D symbol mapper” and “symbol mapping component”; “encoded message” and “transmission”; and “4D symbol de-mapper” and “symbol de-mapping component”.

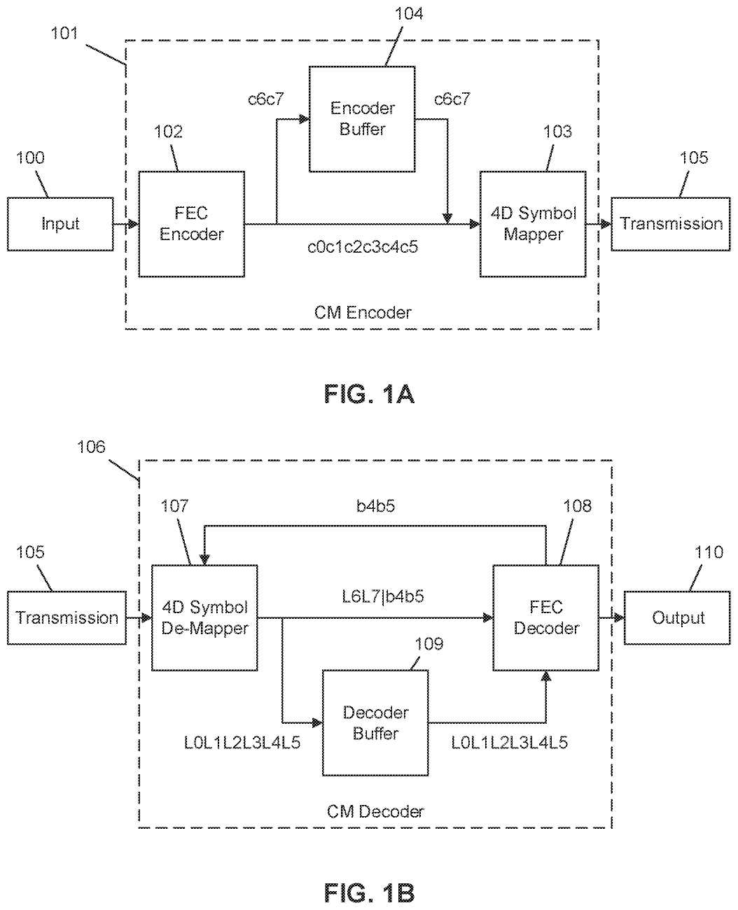

FIG. 1A shows a schematic for CM encoding at a transmitter in accordance with an embodiment of the present disclosure. The transmitter may be coupled to a receiver through an optical communication link. Here, input 100, which may be a plurality of bits representing data (i.e., a “data message”), is received at a CM encoder 101 of the transmitter. The data may be intended for transmission to the receiver through the optical communication link. The CM encoder 101 may comprise an FEC encoder 102 coupled to a four-dimensional (4D) symbol mapper 103 (i.e., a “symbol mapping component”). Each of the FEC encoder 102 and 4D symbol mapper 103 may be coupled to an encoder buffer 104 (i.e., a “buffer component”). The FEC encoder 102 may receive the input 100 and encode it as a plurality of sequences of coded bits in accordance with an FEC scheme. For example, the FEC encoder 102 may encode data as sequences of eight coded bits (i.e., c0c1c2c3c4c5c6c7). The FEC scheme may, for example, be a CFEC or OFEC scheme and may involve one or more FEC codes. The one or more FEC codes may include, for example, zipper codes.

Each sequence of coded bits may be partitioned into a respective first group of coded bits and respective second group of coded bits. Each group of coded bits may define a respective sub-sequence for the coded bits of the group. For example, a sequence of eight coded bits, (i.e., c0c1c2c3c4c5c6c7) may be partitioned into a first group of six coded bits (i.e., c0c1c2c3c4c5) and a second group of two coded bits (i.e., c6c7). The encoder buffer 104 may be used to delay one of the groups of coded bits (e.g., the second group) for each sequence of coded bits. The delay may have a pre-determined duration (or buffer size), which may depend from the length of a code block or window size of the FEC scheme. For example, for convolutional FEC codes, the buffer size may be at least 25% of the window decoding size. A smaller proportion of bits may be partitioned into the first group of bits than the second group to maximize performance while minimizing the delay caused by buffering. Improvements to performance may realize as improvements to spectral efficiency; for example, for a sequence of eight coded bits, when partitioned into a first group of six bits and a second group of two bits, a spectral efficiency equivalent to that of 16-QAM may be expected.

The 4D symbol mapper 103 may map each group of coded bits to a respective symbol. In other words, the first group of coded bits may be mapped to a first symbol and the second group of coded bits may be mapped to a second symbol. The groups may be mapped, in accordance with the delay introduced by the encoder buffer 104, to consecutive symbols or to symbols with a greater separation. Mapping may include identifying a particular constellation point from among a plurality of constellation points for modulation. Each constellation point may have associated with it a modulation amplitude and phase. For example, the groups may be mapped to symbols according to a 16QAM or 64QAM scheme. Each constellation point may be assigned at least one respective sequences of bits (i.e., “mapping bits”) such that mapping a group of coded bits involves matching the respective sub-sequence of the group of coded bits to one of the sequences assigned to a constellation point. In some embodiments, wherein one constellation point has more than one sequence of bits assigned to it, the combination of the constellation point mapped for a first group of coded bits of a sequence and the constellation point mapped for a second group of coded bits of a sequence may be used to uniquely map the sequence. This approach to mapping the coded bits across the two dimensions of amplitude and phase along with the two dimensions provided by the respective constellation points of the first symbol and the second symbol may provide, in total, four dimensions for mapping. In some embodiments, optical properties other than amplitude or phase, such as polarization, time, or frequency, may be used in mapping the groups of coded bits. The symbols produced by the 4D symbol mapper 103 may be sent to the receiver through the optical communication link as a transmission 105 (i.e., an “encoded message”).

FIG. 1B shows a schematic for CM decoding at a receiver in accordance with an embodiment of the present disclosure. The receiver may be the receiver described in relation to FIG. 1A and may be coupled to the transmitter thereof through an optical communication link. In FIG. 1B, the transmission 105, as described in relation to FIG. 1A, may be received by a CM decoder 106 of the receiver. The CM decoder 106 may comprise a 4D symbol de-mapper 107 (i.e., a “symbol de-mapping component”) coupled to an FEC decoder 108. Each of the 4D symbol de-mapper 107 and the FEC decoder 108 may be coupled to a decoder buffer 109 (i.e., another “buffer component”).

The 4D symbol de-mapper 107 may receive the transmission 105 and de-map each first symbol corresponding to a sequence of coded bits to obtain a respective plurality of soft decoded values. Each soft decoded value may be a probability for the correct value of one of the coded bits of the group of coded bits that corresponds to the symbol. For example, each soft decoded value may be a LLR. For a symbol representing a group of six coded bits, the 4D symbol de-mapper 107 may determine six LLRs (i.e., L0L1L2L3L4L5). Each plurality of soft decoded values may be buffered by the decoder buffer 109 for a duration of the delay associated with the corresponding second symbol. The duration here may be sufficient to counteract the delay associated with the corresponding second symbol. Each plurality of soft decoded values may then be decoded as a respective plurality of decoded bits (i.e., b0b1b2b3b4b5). Decoding of the soft decoded values may be done in accordance with the FEC codes used by the CM encoder 101 of the transmitter.

The 4D symbol de-mapper 107 may further de-map each second symbol corresponding to a sequence of coded bits to obtain a respective plurality of soft decoded values. This de-mapping may be done in accordance with a set of decoded bits of the plurality of decoded bits of the corresponding first symbol. For example, when a second symbol represents a group of two coded bits, two decoded bits (i.e., b4b5) may be provided to the 4D symbol de-mapper 107, which may then determine two LLRs (i.e., L6L7). This approach to de-mapping may reduce the bit error rate of the soft decoded values from the second symbol (i.e., L6L7), and may therefore improve the overall bit error rate. The mapping of the second symbol by the 4D symbol mapper 103, as described in relation to FIG. 1A, may be done with consideration of de-mapping using the set of decoded bits of the plurality of decoded bits of the corresponding first symbol. Each plurality of soft decoded values may then be decoded as a respective plurality of decoded bits (i.e., b6b7). Decoding of the soft decoded values may be done in accordance with the FEC codes used by the CM encoder 101 of the transmitter. Thus, the CM decoder 106 may produce as output 110 a plurality of decoded bits for each of the first symbols and second symbols that correspond to data bits of input 100 to the CM encoder 101.

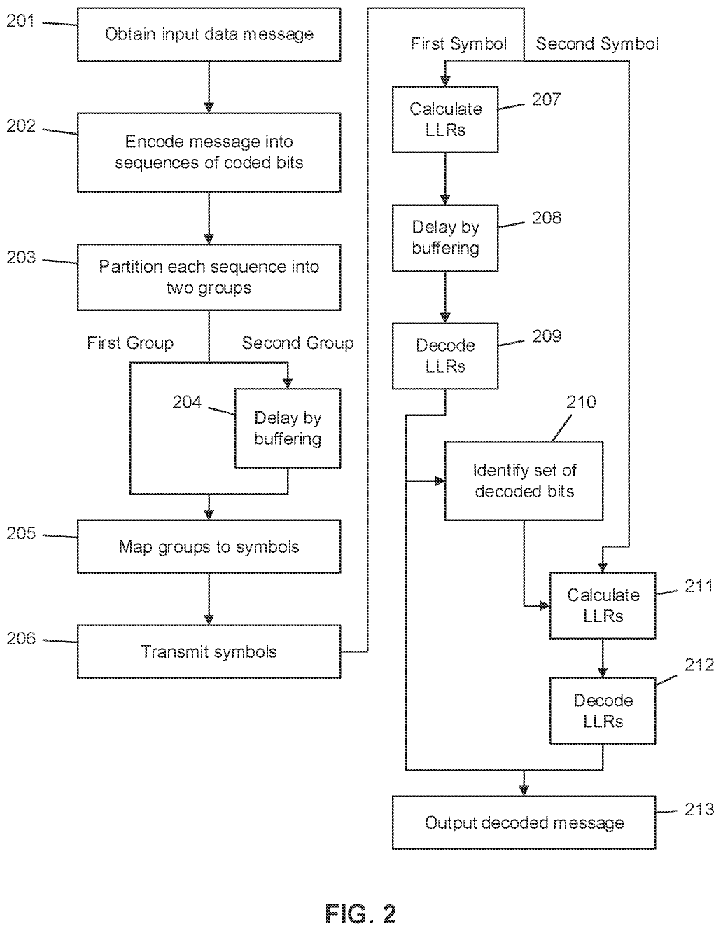

FIG. 2 shows a flowchart of a method for transmitting a data message using CM in accordance with embodiments of the present disclosure. The method of FIG. 2 may be implemented through the CM encoder 101 and CM decoder 106 described in relation to FIGS. 1A and 1B respectively. At action 201, the data message may be obtained by the CM encoder 101 as input 100. At action 202, the data message may be encoded as a plurality of sequences of coded bits in accordance with one or more FEC codes. Each sequence of coded bits may be partitioned, at action 302, into a respective first group of coded bits and a respective second group of coded bits. Each second group of coded bits may be buffered, at action 204, to delay that second group of coded bits with respect to the corresponding first group of coded bits. At action 205, each first group of coded bits may be mapped to a respective first symbol, and each second group of coded bits may be mapped to a respective second symbol, with each second symbol being delayed with respect to the corresponding first symbol. At action 206, each first symbol and each second symbol may then be transmitted through an optical communication link and received by the CM decoder 106.

After the symbols are received, at action 207, a respective plurality of LLRs, or other soft decoded values, may be calculated for each first symbol, with each LLR corresponding to a coded bit of the group of coded bits mapped to the respective first symbol. Each plurality of LLRs may be buffered, at action 208, to delay the LLRs by a duration that may counteract the buffering done at action 204. At action 209, each plurality of LLRs may be decoded, in accordance with the one or more FEC codes, as a respective plurality of decoded bits. From among each plurality of decoded bits, a respective set of decoded bits may be identified, at action 210. At action 211, a respective plurality of LLRs, or other soft decoded values, may be calculated for each second symbol in accordance with the set of decoded bits identified for the corresponding first symbol. At action 212, the respective plurality of LLRs for each second symbol may be decoded, in accordance with the one or more FEC codes, as a respective plurality of decoded bits. At action 213, the decoded bits for each first symbol and each second symbol may be output as a decoded message that corresponds to the data message input at action 201.

In some embodiments of the present disclosure, mapping of each group of coded bits at a transmitter may be done using constellation points selected by geometric shaping.

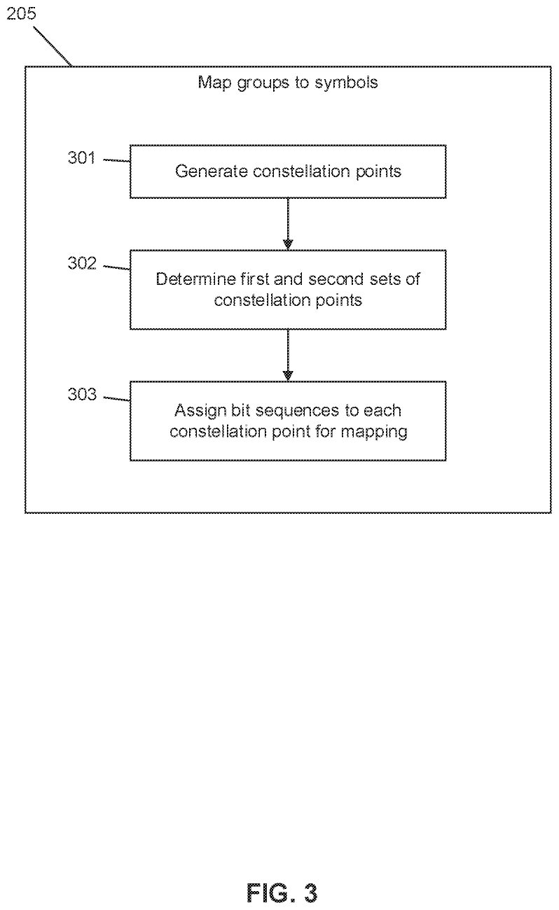

FIG. 3 shows a flowchart of a method for geometric shaping in accordance with an embodiment of the present disclosure. The method of FIG. 3 may be performed, at least in part, for mapping groups of coded bits to symbols, as described in relation to FIG. 2 at action 205. In FIG. 3, at action 301, a plurality of constellation points may be generated. Each constellation point may have associated with it a respective modulation amplitude and phase. The modulation amplitude and phase may be represented by an in-phase component (I) and a quadrature component (Q). In some other embodiments, each constellation point may have associated with it other modulation properties, such as a modulation polarization or frequency. At action 302, a first set of X constellation points and a second set of Y constellation points may be identified from among the plurality of constellation points. For coded modulation in which each sequence of coded bits has N coded bits, the product of X and Y may be greater than or equal to 2. At action 303, at least one sequence of bits may be assigned to each constellation point of the first set and the second set. As described in relation to FIG. 1A, each constellation point may be assigned more than one sequence of bits such that the combination of the constellation point of the first set mapped for a first group of coded bits of a sequence and the constellation point of the second set mapped for a second group of coded bits of a sequence may be used to uniquely map the sequence. In some embodiments, actions 302 and 303 may be done using a neural network. In some of these embodiments, the neural network may be located at the transmitter or at another suitable location, such that each set of constellation points may be obtained by the transmitter. The neural network may identify each set of constellation points and/or assign the respective sequence of bits to each constellation point of the sets to maximize a metric of GMI of the optical communication link. The first set of X constellation points and the second set of Y constellation points may therefore define a grouping of constellation points that corresponds to a maximum of the GMI metric.

In embodiments, the plurality of constellation points may include S≥2^{N/2} constellation points. Thus, the selection of X and Y may be limited by four conditions: S≥2^{N/2}, XY≥2^{N}, S≥X, and S≥Y. For example, for N=8, the plurality of constellation points may need to include at least 16 constellation points (i.e., S≥16). With S=16, each of the first set of X constellation points and the second set of Y constellation points would include all of the plurality of constellation points (i.e., S=X=Y). With S>16, each of the first set of X constellation points and the second set of Y constellation points may include only a portion of the plurality of constellation points (e.g., S=256, X=40, and Y=40). The above conditions may impose lower limits on the selection of X, Y, and S. The selection of X and S may further face diminishing benefits as S>>2^{N/2} and XY>>2^{N}. S, X, and Y may preferably be selected to be sufficiently large to provide sufficient resolution for geometric shaping; however, further increasing their magnitudes may provide minimal incremental benefit towards performance, such as in minimizing intersymbol interference and phase noise, because the differences between combinations of constellation points may diminish. Furthermore, the numbers X and Y may preferably be selected to have the same value (i.e., X=Y).

The metric of GMI may characterize the achievable information rate (AIR) for the optical communication link. The metric of GMI may indicate the statistical dependence between transmitted symbols and received symbols, while accounting for the effects of coding, modulation, mapping, noise and other parameters of the overall communications system, which may thereby provide a measure of information transfer between transmitter and the receiver. For example, the metric of GMI may be calculated as the mutual information between the transmitted and received symbols, that is the difference in entropy of the transmitted symbols and the conditional entropy with the received symbols, less the losses in information rate due to constraints of the communication system. By indicating how much information can be reliably transferred, the metric of GMI may provide an indication for the maximum rate at which information can be reliably transferred, and thus the AIR.

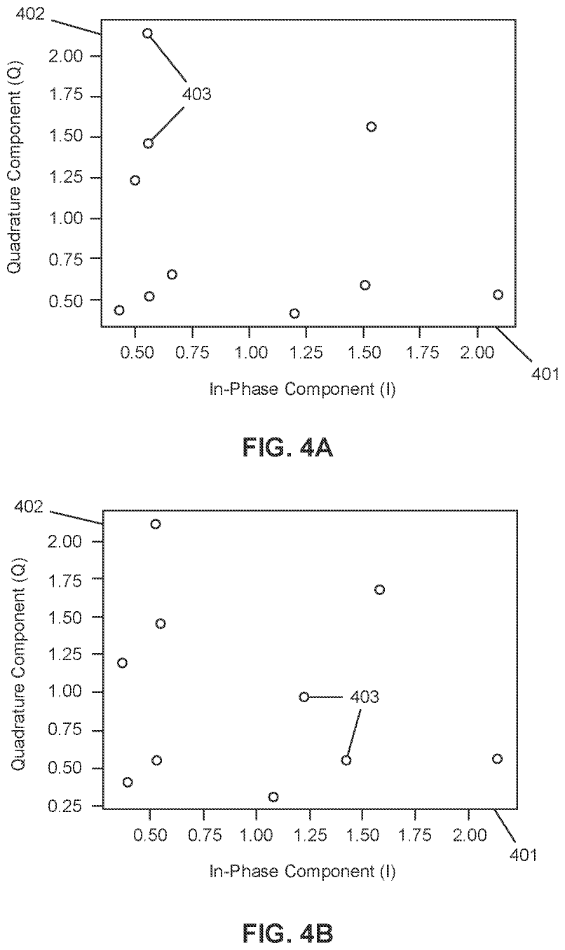

FIG. 4A shows a graph of in-phase component 401 and quadrature component 402 for an example of 10 constellation points 403 from among a first set of 40 constellation points. FIG. 4B shows a graph of in-phase component 401 and quadrature component 402 for an example of 10 constellation points 403 from among a second set of 40 constellation points. In the examples of FIGS. 4A and 4B, each constellation point has been selected from a plurality of 256 constellation points, which were generated for coded modulation with sequences of eight coded bits. With 40 constellation points in each of the first set and the second set, there are 40×40=1600 possible combinations. Thus, the first and second sets of 40 constellation points can together fully represent the 256 possible sequences for eight coded bits. Furthermore, each set of 40 constellation points can be selected from among the plurality of 256 constellation points to optimize the GMI of the optical communication link. This optimization, with the CM of embodiments of the present disclosure, may narrow the gap between 16QAM and the Shannon limit by about 0.4 dB.

Embodiments of the present disclosure may be implemented using electronics hardware, software, or a combination thereof. In some embodiments, the invention may be implemented by one or multiple computer processors executing program instructions stored in memory. In some embodiments, the invention may be implemented partially or fully in hardware, for example using one or more field programmable gate arrays (FPGAs) or application specific integrated circuits (ASICs) to rapidly perform processing operations.

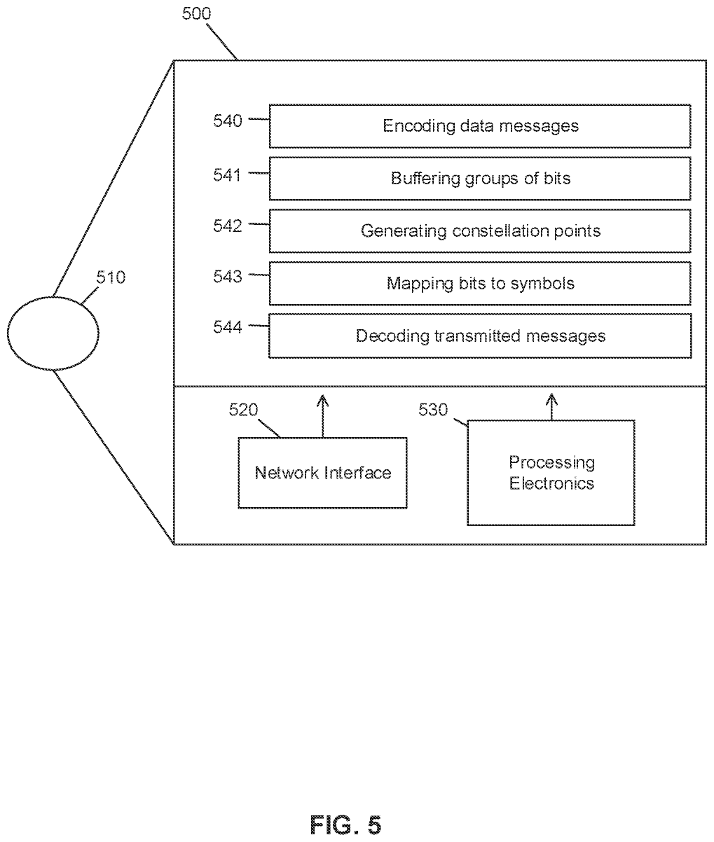

FIG. 5 shows an apparatus 500 for transmitting a message by CM across a network, according to embodiments of the present invention. The apparatus may be located at a node 510 of the network. The apparatus may include a network interface 520 and processing electronics 530. The processing electronics 530 may include a computer processor executing program instructions stored in memory, or other electronics components such as digital circuitry, including for example FPGAs and ASICs. The network interface 520 may include an optical communication interface or radio communication interface, such as a transmitter and receiver. The apparatus may include several functional components, each of which may be partially or fully implemented using the underlying network interface 520 and processing electronics 530. Examples of functional components may include modules for encoding 540 data messages, buffering 541 groups of bits, generating 542 constellation points, mapping 543 bits to symbols, and decoding 544 transmitted messages.

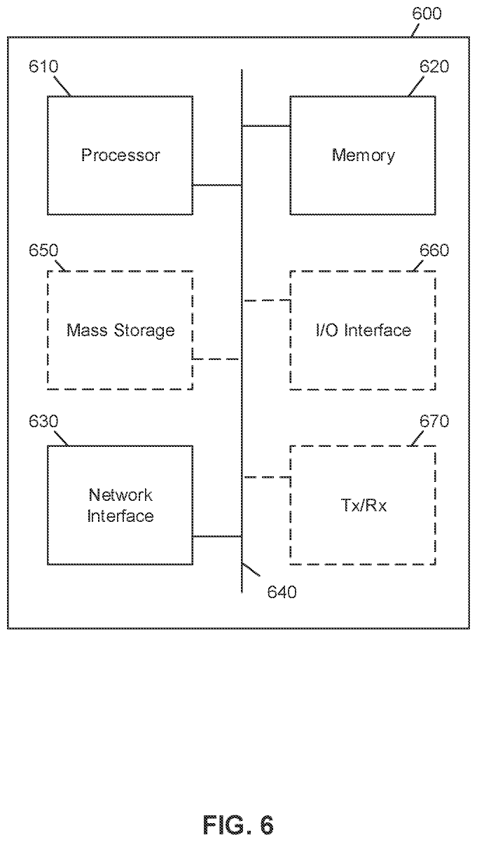

FIG. 6 shows a schematic diagram of an electronic device 600 that may perform any or all of the operations of the above methods and features explicitly or implicitly described herein, according to different embodiments of the present disclosure. For example, a computer equipped with network functions may be configured as an electronic device 600. The electronic device 600 may be used to implement the apparatus 500 of FIG. 5, for example. The electronic device 600 may further be used as part of a network transmitter device or a network receiver device, for example.

As shown, the electronic device 600 may include a processor 610, such as a Central Processing Unit (CPU) or specialized processors such as a Graphics Processing Unit (GPU) or other such processor unit, memory 620, network interface 630, and a bi-directional bus 640 to communicatively couple the components of electronic device 600. Electronic device 600 may also optionally include non-transitory mass storage 650, an I/O interface 660, and a transceiver 670. According to certain embodiments, any or all of the depicted elements may be utilized, or only a subset of the elements. Further, the electronic device 600 may contain multiple instances of certain elements, such as multiple processors, memories, or transceivers. Also, elements of the hardware device may be directly coupled to other elements without the bi-directional bus 640. Additionally, or alternatively to a processor and memory, other electronics, such as integrated circuits, may be employed for performing the required logical operations.

The memory 620 may include any type of tangible, non-transitory memory such as static random access memory (SRAM), dynamic random access memory (DRAM), synchronous DRAM (SDRAM), read-only memory (ROM), any combination of such, or the like. The mass storage element 750 may include any type of tangible, non-transitory storage device, such as a solid state drive, a hard disk drive, a magnetic disk drive, an optical disk drive, a USB drive, or any computer program product configured to store data and machine executable program code. According to certain embodiments, the memory 620 or mass storage 650 may have recorded thereon statements and instructions executable by the processor 610 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method for a transmitter to provide a data message to a receiver, the data message having a plurality of data bits, the method comprising, at the transmitter:
encoding, in accordance with one or more forward error correction codes, the plurality of data bits to obtain a plurality of sequences of coded bits;
partitioning each sequence of coded bits into a respective first group of coded bits and a respective second group of coded bits; and
for each sequence of coded bits:
buffering the respective second group of coded bits to delay, by a pre-determined duration, the respective second group of coded bits with respect to the respective first group of coded bits;
mapping the respective first group of coded bits to a respective first symbol;
mapping the respective second group of coded bits to a respective second symbol;
transmitting, to the receiver through an optical communication link, the respective first symbol; and
subsequently transmitting, to the receiver, through the optical communication link, in accordance with the pre-determined duration, the respective second symbol.

2. The method of claim 1 wherein:
each sequence of coded bits has N data bits, N being a natural integer;
for each sequence of coded bits, the respective first group of coded bits defines a respective first sub-sequence of data bits and the respective second group of coded bits defines a respective second sub-sequence of data bits;
the method further comprises, at the transmitter:
obtaining a first set of X constellation points and a second set of Y constellation points, X and Y being natural integers and having a product greater than or equal to two raised to the power of N, each constellation point of the first set of X constellation points and the second set of Y constellation points corresponding to an amplitude and phase and having associated thereto at least one respective sequence of mapping bits; and
for each sequence of coded bits:
mapping the respective first group of coded bits to the respective first symbol includes assigning, to the respective first group of coded bits, a respective first constellation point from among the first set of X constellation points in accordance with the respective sequence of mapping bits and the respective first sub-sequence of data bits,
mapping the respective second group of coded bits to the respective second symbol includes assigning, to the respective second group of coded bits, a respective second constellation point from among the second set of Y constellation points in accordance with the respective sequence of mapping bits and the respective second sub-sequence of data bits,
the respective first symbol has the amplitude and phase corresponding to the respective first constellation point, and
the respective second symbol has the amplitude and phase corresponding to the respective second constellation point.

3. The method of claim 2 wherein:
the optical communication link has associated thereto a generalized mutual information (GMI) metric;
the first set of X constellation points and the second set of Y constellation points define a grouping of constellation points,
and
the grouping of constellation points correspond to a maximum of the GMI metric.

4. The method of claim 1 wherein:
each sequence of coded bits has B coded bits, B being a natural integer; and
the pre-determined duration depends from B.

5. The method of claim 1 wherein the one or more forward error correction codes includes at least one zipper code.

6. The method of claim 1 wherein:
each sequence of coded bits includes eight coded bits; and,
for each sequence of coded bits:
the respective first group of coded bits includes six coded bits, and
the respective second group of coded bits includes two coded bits.

7. A method for decoding an encoded message, the method comprising, at a receiver:
receiving, from a transmitter, the encoded message through an optical communication link, the encoded message including a plurality of first symbols and a plurality of second symbols, each one of the plurality of second symbols corresponding to a respective one of the plurality of first symbols and having associated thereto a delay with respect to the corresponding first symbol;
for each one of the plurality of first symbols:
de-mapping the respective first symbol to obtain a respective plurality of soft decoded values;
buffering the respective plurality of soft decoded values for a duration of the delay of the corresponding second symbol; and
decoding, in accordance with one or more forward error correction (FEC) codes, the respective plurality of soft decoded values to obtain a respective plurality of decoded bits; and,
for each one of the plurality of second symbols:
de-mapping, in accordance with a respective set of decoded bits of the corresponding first symbol, the respective second symbol to obtain a respective plurality of soft decoded values; and
decoding, in accordance with the one or more FEC codes, the respective plurality of soft decoded values to obtain a respective plurality of decoded bits.

8. The method of claim 7 wherein, for each one of the plurality of first symbols and each one of the plurality of second symbols, each one of the respective plurality of soft decoded values is a log likelihood ratio.

9. The method of claim 7 wherein:
for each one of the plurality of first symbols,
the respective plurality of soft decoded values includes six soft decoded values, and
the respective plurality of decoded bits includes six decoded bits; and
for each one of the plurality of second symbols,
the respective plurality of soft decoded values includes two soft decoded values,
the respective plurality of decoded bits includes two decoded bits, and
the respective set of decoded bits of the corresponding first symbol includes two decoded bits of the corresponding first symbol.

10. A method for providing a sequence of N data bits of a data message to a receiver, N being a natural integer, the method comprising, at a transmitter:
partitioning the sequence of N data bits into a first sub-sequence of data bits and a second sub-sequence of data bits;
obtaining a first set of X constellation points and a second set of Y constellation points, X and Y being natural integers and having a product greater than or equal to two raised to the power of N, each constellation point of the first set of X constellation points and the second set of Y constellation points corresponding to an amplitude and phase and having associated thereto at least one respective sequence of mapping bits;
assigning:
to the first sub-sequence of data bits, a first constellation point from among the first set of X constellation points in accordance with the at least one respective sequence of mapping bits, and
to the second sub-sequence of data bits, a second constellation point from among the second set of Y constellation points in accordance with the at least one respective sequence of mapping bits; and
transmitting, to the receiver through an optical communication link:
a first symbol having the amplitude and phase corresponding to the first constellation point, and
a second symbol having the amplitude and phase corresponding to the second constellation point.

11. The method of claim 10 wherein:
the optical communication link has associated thereto a generalized mutual information (GMI) metric;
the first set of X constellation points and the second set of Y constellation points define a grouping of constellation points,
and
the grouping of constellation points correspond to a maximum of the GMI metric.

12. The method of claim 10 wherein:
N is eight,
X is 40, and
Y is 40.

13. A network system comprising:
a transmitter configured to:
encode a data message as a plurality of sequences of coded bits in accordance with one or more forward error correction (FEC) codes, each sequence of coded bits including a respective first group of coded bits and a respective second group of coded bits; and
for each sequence of coded bits:
buffer the respective second group of coded bits to delay, by a pre-determined duration, the respective second group of coded bits with respect to the respective first group of coded bits,
map the respective first group of coded bits to a respective first symbol and the respective second group of coded bits to a respective second symbol, and
transmit the respective first symbol and the respective second symbol;
an optical communication link; and
a receiver coupled to the transmitter through the optical communication link and configured to, for each sequence of coded bits:
receive the respective first symbol and the respective second symbol;
de-map the respective first symbol to obtain a respective first plurality of soft decoded values;
buffer the respective first plurality of soft decoded values for the pre-determined duration;
decode, in accordance with the one or more FEC codes, the respective first plurality of soft decoded values to obtain a respective first plurality of decoded bits;
de-map, in accordance with a respective set of decoded bits of the respective first symbol, the respective second symbol to obtain a respective second plurality of soft decoded values; and
decode, in accordance with the one or more FEC codes, the respective second plurality of soft decoded values to obtain a respective second plurality of decoded bits.

14. The network system of claim 13 wherein:
each sequence of coded bits has N data bits, N being a natural integer;
for each sequence of coded bits, the respective first group of coded bits defines a respective first sub-sequence of data bits and the respective second group of coded bits defines a respective second sub-sequence of data bits;
the transmitter is further configured to:
obtain a first set of X constellation points and a second set of Y constellation points, X and Y being natural integers and having a product greater than or equal to two raised to the power of N, each constellation point of the first set of X constellation points and the second set of Y constellation points corresponding to an amplitude and phase and having associated thereto at least one respective sequence of mapping bits;
the transmitter being configured to, for each sequence of coded bits:
map the respective first group of coded bits to the respective first symbol includes being configured to assign, to the respective first group of coded bits, a respective first constellation point from among the first set of X constellation points in accordance with the at least one respective sequence of mapping bits and the respective first sub-sequence of data bits, and
map the respective second group of coded bits to the respective second symbol includes being configured to assign, to the respective second group of coded bits, a respective second constellation point from among the second set of Y constellation points in accordance with the at least one respective sequence of mapping bits and the respective second sub-sequence of data bits, and
for each sequence of coded bits:
the respective first symbol has the amplitude and phase corresponding to the respective first constellation point, and
the respective second symbol has the amplitude and phase corresponding to the respective second constellation point.

15. The network system of claim 13 wherein the transmitter is further configured to:
partition each sequence of coded bits to produce the respective first group of coded bits and the respective second group of coded bits.

16. The network system of claim 13 wherein, for each sequence of coded bits, each one of the respective first plurality of soft decoded values and each one of the respective second plurality of soft decoded values is a log likelihood ratio.

17. A network transmitter device comprising:
a forward error correction (FEC) encoder configured to encode a data message as a plurality of sequences of coded bits in accordance with one or more FEC codes, each sequence of coded bits including a respective first group of coded bits and a respective second group of coded bits;
a buffer component configured to buffer, for each sequence of coded bits, the respective second group of coded bits to delay, by a pre-determined duration, the respective second group of coded bits with respect to the respective first group of coded bits; and
a symbol mapping component configured to map, for each sequence of coded bits, the respective first group of coded bits to a respective first symbol and the respective second group of coded bits to a respective second symbol.

18. The network transmitter device of claim 17 wherein:
each sequence of coded bits has N data bits, N being a natural integer;
for each sequence of coded bits, the respective first group of coded bits defines a respective first sub-sequence of data bits and the respective second group of coded bits defines a respective second sub-sequence of data bits;
the symbol mapping component is further configured to:
obtain a first set of X constellation points and a second set of Y constellation points, X and Y being natural integers and having a product greater than or equal to two raised to the power of N, each constellation point of the first set of X constellation points and the second set of Y constellation points corresponding to an amplitude and phase and having associated thereto at least one respective sequence of mapping bits;
the symbol mapping component being configured to, for each sequence of coded bits:
map the respective first group of coded bits to the respective first symbol includes being configured to assign, to the respective first group of coded bits, a respective first constellation point from among the first set of X constellation points in accordance with the at least one respective sequence of mapping bits and the respective first sub-sequence of data bits, and
map the respective second group of coded bits to the respective second symbol includes being configured to assign, to the respective second group of coded bits, a respective second constellation point from among the second set of Y constellation points in accordance with the at least one respective sequence of mapping bits and the respective second sub-sequence of data bits, and
for each sequence of coded bits:
the respective first symbol has the amplitude and phase corresponding to the respective first constellation point, and
the respective second symbol has the amplitude and phase corresponding to the respective second constellation point.

19. A network receiver device comprising a symbol de-mapping component coupled to a forward error correction (FEC) decoder, the network receiver device further comprising a buffer component coupled to the symbol de-mapping component and the FEC decoder,
the symbol de-mapping component configured to:
receive an encoded message including a plurality of first symbols and a plurality of second symbols, the encoded message encoded with one or more FEC codes, each one of the plurality of second symbols corresponding to a respective one of the plurality of first symbols and having associated thereto a delay with respect to the corresponding first symbol; and
de-map each one of the plurality of first symbols to obtain a respective plurality of soft decoded values;
the buffer component configured to buffer, for each one of the plurality of first symbols, the respective plurality of soft decoded values for a duration of the delay of the corresponding second symbol;
the FEC decoder configured to decode, for each one of the plurality of first symbols and in accordance with the one or more FEC codes, the respective plurality of soft decoded values to obtain a respective plurality of decoded bits;
the symbol de-mapping component further configured to de-map each one of the plurality of second symbols, in accordance with a respective set of decoded bits of the corresponding first symbol, to obtain a respective plurality of soft decoded values; and
the FEC decoder further configured to decode, for each one of the plurality of second symbols and in accordance with the one or more FEC codes, the respective plurality of soft decoded values to obtain a respective plurality of decoded bits.

20. The network receiver device of claim 19 wherein, for each one of the plurality of first symbols and each one of the plurality of second symbols, each one of the respective plurality of soft decoded values is a log likelihood ratio.
